(19) United States
(12) Patent Application Publication
(10) Pub. No.: US 2024/0332714 A1
(43) Pub. Date: Oct. 3, 2024

(54) METHOD OF MANUFACTURING BATTERY CELL STACK

(71) Applicant: SK ON CO., LTD., Seoul (KR)

(72) Inventors: Seung Won LEE, Daejeon (KR); Jae Hun KIM, Daejeon (KR); Yoon Sung OH, Daejeon (KR); Seul Gi LEE, Daejeon (KR); Min Jeong HONG, Daejeon (KR)

(21) Appl. No.: 18/599,202

(22) Filed: Mar. 8, 2024

(30) Foreign Application Priority Data
Mar. 28, 2023 (KR) 10-2023-0040207

(51) Int. Cl. H01M 50/264; H01M 10/052; H01M 50/211

(52) U.S. Cl. CPC H01M 50/264; H01M 10/052; H01M 50/211

(57) ABSTRACT

In a method of manufacturing a battery cell stack, a lower battery cell and an upper battery cell are aligned with an bonding space therebetween in a stacking direction of battery cells. A distance in the stacking direction between an upper surface of the lower battery cell and a lower surface of the upper battery cell is continuously measured along a length direction or a width direction of the battery cells to derive a bonding space profile. An adhesive resin composition is sprayed along the length direction or the width direction while changing a moving rate of a nozzle based on a thickness of the profile. The lower surface of the upper battery cell are attached onto the sprayed adhesive resin composition.

### CROSS-REFERENCE TO RELATED APPLICATION AND CLAIM OF PRIORITY

This application claims priority to Korean Patent Application No. 10-2023-0040207 filed on Mar. 28, 2023 in the Korean Intellectual Property Office (KIPO), the entire disclosure of which is incorporated by reference herein.

### BACKGROUND

### 1. Field

The disclosure of this patent document relates to a method of manufacturing a battery cell stack.

### 2. Description of the Related Art

A secondary battery capable of being charged and discharged has been actively researched according to developments of high-tech fields such as a digital camera, a cellular phone, a laptop, a hybrid vehicle, etc. Examples of the secondary battery may include a nickel-cadmium battery, a nickel-metal hydride battery, a nickel-hydrogen battery, a lithium secondary battery, etc.

A lithium secondary battery has high operating voltage and energy density per unit weight, and has been used as a power source for portable electronic devices. Further, a plurality of lithium secondary batteries are connected to be applied to high-power hybrid vehicle and electric vehicle.

When the lithium secondary battery is used as a power source for the high-power hybrid vehicle and electric vehicle, a plurality of the secondary batteries may be connected to be used in the form of a battery module and a battery pack to increase a capacity and a power of the battery. To implement the battery module or the battery pack, various fastening components or cooling equipment are required. However, the fastening components or the cooling equipment may increase a production cost, a volume and a weight of the battery module to reduce a power efficiency relative to the volume and the weight.

For example, a cell stack in the form of a battery module may be manufactured by attaching an adhesive such as a tape to a cell surface. However, additional processes and equipment are required for an tape input and a release paper removal, and a large amount of wastes such as the release paper may be generated.

Further, an outer surface of a battery cell may have a low flatness due to deformation of the surface due to swelling or a shape of an electrode assembly at an inside of the battery cell. In this case, an effective adhesion area may be reduced when the battery cells are stacked, and an adhesion force of an adhesive may not be sufficiently provided. Accordingly, stability and reliability of the battery module may be deteriorated.

### SUMMARY

According to an aspect of the present disclosure, there is provided a method of manufacturing a battery cell stack having an enhanced adhesion between cells.

In a method of manufacturing a battery cell stack, a lower battery cell and an upper battery cell are aligned with a bonding space interposed therebetween in a stacking direction of battery cells. A distance in the stacking direction between an upper surface of the lower battery cell and a lower surface of the upper battery cell is continuously measured along a length direction or a width direction of the battery cells to derive a bonding space profile. An adhesive resin composition is sprayed on the upper surface of the lower battery cell along the length direction or the width direction while changing a moving rate of a nozzle based on a thickness of the profile. The lower surface of the upper battery cell is attached onto the sprayed adhesive resin composition.

In some embodiments, in spraying the adhesive resin composition, a moving rate of the nozzle may be reduced when the thickness of the bonding space profile increases, and the moving rate of the nozzle may be increased when the thickness of the bonding space profile decreases.

In some embodiments, in deriving the bonding space profile, a difference between a reference thickness of the lower battery cell and an actual height from a first reference surface in contact with a lower surface of the lower battery cell to the upper surface of the lower battery cell may be measured to derive an upper surface profile of the lower battery cell. A difference between a reference thickness of the upper battery cell and an actual height from a second reference surface in contact with an upper surface of the upper battery cell to the lower surface of the upper battery cell may be measured to derive a lower surface profile of the upper battery cell. A distance between the lower surface profile of the upper battery cell and the upper surface profile of the lower battery cell may be continuously measured.

In some embodiments, deriving the upper surface profile of the lower battery cell and deriving the lower surface profile of the upper battery cell may be performed by irradiating a laser on each of the upper surface of the lower battery cell and the lower surface of the upper battery cell in the stacking direction.

In some embodiments, the bonding space profile may include a first region and a second region spaced apart from each other in the length direction or the width direction. The adhesive resin composition may be continuously sprayed in each of the first region and the second region.

In some embodiments, the bonding space profile may include a spray pause section in a space between the first region and the second region.

In some embodiments, in spraying the adhesive resin composition while changing the moving rate of the nozzle, a reference rate when a thickness of the bonding space profile is a reference value may be set. The moving rate of the nozzle may be reduced when the thickness of the bonding space profile is greater than the reference value, and the moving rate of the nozzle may be increased when the thickness of the bonding space profile is smaller than the reference value.

In some embodiments, in deriving the bonding space profile, a distance in the stacking direction may be continuously measured along both the length direction and the width direction to generate a three-dimensional profile of the bonding space.

In some embodiments, the adhesive resin composition may be continuously sprayed along the length direction and the width direction based on the three-dimensional profile.

In some embodiments, each of the lower battery cell and the upper battery cell may include an electrode assembly including a plurality of anodes and cathodes, an electrolyte solution impregnating the electrode assembly, and a case accommodating the electrode assembly and the electrolyte solution.

In some embodiments, the lower battery cell and the upper battery cell may each include a pouch-type battery cell.

In some embodiments, the adhesive resin composition may include a solvent-free adhesive.

In some embodiments, the solvent-free adhesive may include the group consisting of an ethylene vinyl acetate resin, a polyamide resin, a fatty acid polyamide resin, a polyester resin, a polyurethane resin, a polyolefin resin, a styrene-based resin and/or a rubber-based resin.

In some embodiments, the adhesive resin composition may be sprayed at a temperature in a range from 140° C. to 200° C.

In a method of manufacturing a battery cell stack according to embodiments the present disclosure, a coating amount of an adhesive resin composition may be adjusted in consideration of an external contour of a plurality of battery cells.

Accordingly, an amount of the adhesive resin composition used for battery cell stacking may be reduced. Further, when an outer surface of a battery cell is not flat, the adhesive resin composition may be applied to be compatible with the outer contours of the battery cells to be stacked. Thus, an adhesion force between the battery cells may be improved.

In a method of manufacturing a battery cell stack according to embodiments the present disclosure, the battery cells may be prevented from slipping during the battery cell stacking. Thus, a defect ratio of a flatness of the battery cell stack may be reduced.

### BRIEF DESCRIPTION OF THE DRAWINGS

FIG. 1 is a flow diagram for describing a method of manufacturing a battery cell stack in accordance with example embodiments.

FIG. 2 is a cross-sectional view illustrating a state in which an upper battery cell and a lower battery cell are disposed in a stacking direction in accordance with some embodiments.

FIG. 3 is a three-dimensional graph showing a lower surface profile of an upper battery cell in accordance with an example embodiment.

FIG. 4 is a three-dimensional graph showing an upper profile of a lower battery cell in accordance with an example embodiment.

FIG. 5 is a schematic cross-sectional view illustrating an adhesive resin composition applied on a lower battery cell in accordance with an example embodiment.

FIG. 6 is a schematic cross-sectional view of a battery cell stack in accordance with an example embodiment.

FIG. 7 is a schematic cross-sectional view of a battery cell stack in accordance with an example embodiment.

### DETAILED DESCRIPTION OF THE EMBODIMENTS

The terms “top”, “bottom”, “upper”, “lower”, “one end”, “other end”, “on”, etc., used herein are intended to describe the relative positional relationship of elements and do not designate absolute positions.

The term “adhesive resin composition” used herein may refer to a composition including a resin component. The adhesive resin composition may be a pressure sensitive adhesive composition or a bonding composition.

The term “non-solvent type adhesive” or “solvent-free adhesive” used herein may refer to a thermoplastic adhesive that is formed of a thermoplastic-resin without using a solvent or other solvent, and may be melted at a temperature of a melting point or more and solidified by cooling. The non-solvent type adhesive may be a heat-melting adhesive that may be applied to an adhesion object in a liquid state at a high temperature and may provide an adhesion while cooling and solidifying within a few seconds by dissipating a heat around a surface of the adhesion object after being compressed.

The term “Pressure Sensitive Adhesive (PSA)” may refer to an adhesive that provides an adhesion when a pressure is applied to the adhesive to adhere to the adhesive surface.

Hereinafter, embodiments of the present inventive concepts will be described in detail with reference to exemplary embodiments and the accompanying drawings. However, those skilled in the art will appreciate that such embodiments and drawings are provided to further understand the spirit of the present invention and do not limit subject matters to be protected as disclosed in the detailed description and appended claims.

In example embodiments, a upper battery cell and a lower battery cell may each include a general battery cell. The lower battery cell and the upper battery cell may include an electrode assembly including a plurality of cathodes and anodes; an electrolyte impregnating the electrode assembly, and a case accommodating the electrode assembly and the electrolyte. For example, the upper battery cell and the lower battery cell may be provided as a lithium secondary battery.

In example embodiments, the anode may include an anode active material. For example, the anode may include an anode active material layer on at least one surface of an anode current collector.

In example embodiments, the anode active material layer may include an anode active material. For example, the anode active material above may be a material capable of intercalating and de-intercalating lithium ions. For example, the anode active material may include a lithium alloy, a carbon-based material such as a graphite-based active material, a silicon-based material, etc.

In example embodiments, the graphite-based active material above may include artificial graphite or natural graphite. If the graphite-based active material above includes natural graphite and artificial graphite, an amount of natural graphite may be greater than an amount of artificial graphite in the graphite-based active material.

For example, the anode active material, an anode binder, a conductive material, a dispersive agent, etc., may be mixed and stirred to form a slurry. The slurry may be coated, dried and pressed on the anode current collector to form the anode.

In example embodiments, the cathode may include a cathode active material layer. For example, the cathode may include a cathode active material layer on at least one surface of a cathode current collector.

In example embodiments, the cathode active material layer may include a cathode active material. For example, the cathode active material above may include a lithium metal oxide capable of reversibly intercalating and de-intercalating lithium ions.

The cathode active material above may include a lithium-nickel metal composite oxide. In some examples, the lithium-nickel metal composite oxide may be represented by Chemical Formula below

### [Chemical Formula]

LiₓNi_{(1-a-b)}CoₐM_{b}O_{y}

In the above Chemical Formula, M may include at least one of Al, Zr, Ti, Cr, B, Mg, Mn, Ba, Si, Y, W and Sr, and 0.9≤x≤1.2, 1.9≤y≤2.1 and 0≤a+b≤0.2.

In example embodiments, the cathode active material layer may further include a cathode binder and a conductive material. For example, the cathode active material, the cathode binder, the conductive material, a dispersive agent, etc., may be mixed and stirred to prepare a cathode slurry. The cathode slurry may be coated, dried and pressed on the cathode current collector to form the cathode.

In example embodiments, a separator may be interposed between the cathode and the anode.

For example, the separator may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, etc. The separator may be also formed from a non-woven fabric including a glass fiber with a high melting point, a polyethylene terephthalate fiber, etc.

For example, an electrode cell may be defined by the cathode, the anode and the separator, and a plurality of the electrode cells may be stacked to form an electrode assembly. For example, the electrode assembly may be formed by winding, stacking or zigzag-folding of the separator.

The electrode assembly may be accommodated together with the electrolyte in a case 160 to define the lithium secondary battery (the upper and lower battery cells). In example embodiments, a non-aqueous electrolyte solution may be used as the electrolyte.

For example, the non-aqueous electrolyte solution may include a lithium salt and a solvent. The lithium salt may be represented by Li⁺X⁻. An anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The solvent may include an acetate-based solvent, a carbonate-based solvent, etc.

For example, the acetate-based solvent may include at least one selected from the group consisting of methyl acetate (MA), ethyl acetate (EA) and propyl acetate (PA). In an embodiment, the acetate-based solvent may include ethyl acetate.

For example, the carbonate-based solvent may include propylene carbonate (PC), ethylene carbonate (EC), diethyl carbonate (DEC), dimethyl carbonate (DMC), ethyl methyl carbonate (EMC), methylpropyl carbonate, dipropyl carbonate, vinylene carbonate, etc. These may be used alone or in a combination of two or more therefrom.

In example embodiments, the electrolyte may further include an additive. The additive may include dimethyl sulfoxide, acetonitrile, dimethoxyethane, diethoxyethane, vinylene carbonate, sulfolane, gamma-butyrolactone, propylene sulfite, tetrahydrofuran, etc.

In example embodiments, the lower battery cell and the upper battery cell may be manufactured in a cylindrical shape, a prismatic shape, a pouch shape or a coin shape. In some embodiments, each of the lower battery cell and the upper battery cell may be a pouch-type battery cell

A pouch case of the pouch-type battery cell may be relatively easily deformed. Accordingly, irregularities may exist in an external contour of the battery cell. Therefore, the pouch-type battery cells are stacked using a method of manufacturing a battery cell stack to be described later, so that an adhesive force between the battery cells may be enhanced.

The lithium secondary battery or the battery cell may include an electrode lead which is connected to the electrode and protrudes to an outside of the case.

Each of the cathode current collector of the cathode and the anode current collector of the anode may include a notched portion. The notched portion may serve as an electrode tab. The notched portion may include a cathode notched portion protruding from the cathode current collector and an anode notched portion protruding from the anode current collector.

For example, the electrode current collector may include a protrusion (a cathode tab and an anode tab) at one side thereof. The electrode active material layer may not be formed on the electrode tab. The electrode tab may be integral or connected with the electrode current collector by, e.g., welding. The electrode current collector and the electrode lead may be electrically connected via the electrode tab.

In one embodiment, the electrode assembly may include a plurality of the cathodes and a plurality of the anodes. For example, the cathodes and the anodes may be alternately stacked, and the separator may be interposed between the anode and the cathode. Accordingly, the lithium secondary battery or the battery cell may include a plurality of anode tabs and a plurality of cathode tabs protruding from each of the plurality of the anodes and the plurality of cathodes.

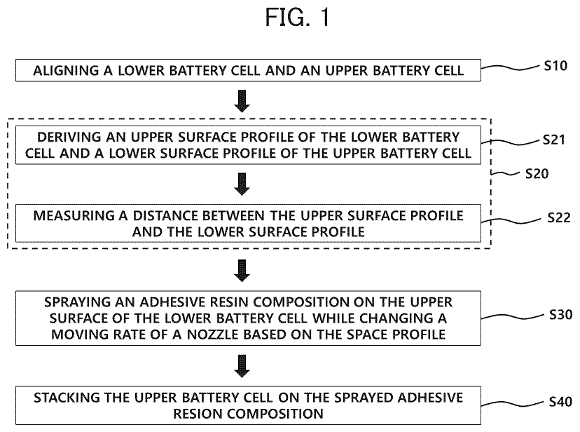

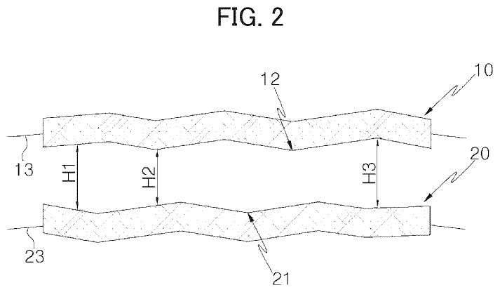

FIG. 1 is a schematic flow diagram for describing a method of manufacturing a batter module in accordance with example embodiments. FIG. 2 is a cross-sectional view illustrating a state in which an upper battery cell and a lower battery cell are disposed in a stacking direction in accordance with some embodiments.

Referring to FIGS. 1 and 2, a lower battery cell 20 and an upper battery cell 10 may be aligned in a stacking direction of a battery cell with a bonding space therebetween (e.g., in an operation of S10). Before stacking the lower battery cell 20 and the upper battery cell 10, the battery cells may be spatially arranged to analyze a shape of the bonding space.

Each of the upper battery cell 10 and the lower battery cell 20 may include an electrode lead 13 and 23 protruding to an outside of the battery cell.

In example embodiments, an bonding space profile (hereinafter, abbreviated as a space profile) may be derived (e.g., an operation of S20). The bonding space may be defined as a space between an upper surface of the lower battery cell 20 and a lower surface of the upper battery cell 10. The “bonding space profile” may refer to a three-dimensional virtual model derived from a shape standard data of a space in which the adhesive resin composition is to be applied between the lower battery cell and the upper battery cell.

A profile of a lower surface 12 of the upper battery cell 10 and a profile of an upper surface 21 of the lower battery cell 20 may be derived to derive the space profile. The space profile may be a profile of a space to which the adhesive resin composition is to be applied as a space separated between the upper battery cell 10 and the lower battery cell 20 including arbitrary points indicated by H1, H2 and H3 of FIG. 2.

The lower battery cell 20 and the upper battery cell 10 may have irregularities on the surfaces thereof. For example, the lower and upper battery cells may be pouch-type battery cells, and the electrode assembly may be accommodated in a pouch-type case. A shape of the pouch-type case may not be fixed. In this case, an outer surface of the battery cell may have an uneven shape, and the surface may not be smooth. Accordingly, when the battery cells are attached using a conventional double-sided adhesive tape is used, an adhesion compatibility between the battery cells may be degraded.

In example embodiments, the space profile can be derived so that an appropriate amount of the adhesive resin composition may be sprayed to match the bonding space. Accordingly, the battery cell stack may include a plurality of the battery cells firmly coupled to each other, and slipping between the battery cells due to a shape of the adhesive layer filled in the irregularities may be reduced.

The space profile may be derived by measuring a distance in the stacking direction between the upper surface 21 of the lower battery cell 20 and the lower surface 12 of the upper battery cell 10. In some embodiments, the distance in the stacking direction may be continuously measured along a length direction or a width direction of the battery cell.

The distance in the stacking direction may be measured while the lower battery cell 20 and the upper battery cell 10 are disposed, or may be derived by analyzing each shape of the upper surface 21 of the lower battery cell 20 and the lower surface 12 of the upper battery cell 10.

For example, profiles of the upper surface 21 of the lower battery cell 20 and the lower surface 12 of the upper battery cell 10 may be derived, and a distance between the profile of the lower surface 12 of the upper battery cell 21 and the profile of the upper surface 21 of the lower battery cell 20 may be continuously measured to derive the space profile (e.g., operations of S21 and S22).

For example, the profile of the upper surface 21 of the lower battery cell 20 may be derived by measuring a difference between a reference thickness of the lower battery cell 20 and an actual height from a first reference surface contacting the lower surface of the lower battery cell 20 to the upper surface 21 of the lower battery cell 20.

In some embodiments, in a state that the lower surface of the lower battery cell 20 is in contact with the first reference surface, the difference between the reference thickness of the battery cell and the actual height of each point may be continuously measured by irradiating a laser on the upper surface 21 of the lower battery cell 20 in the stacking direction (e.g., vertical direction) to derive the profile of the upper surface 21 of the lower battery cell 20.

Additionally, the profile of the lower surface 12 of the upper battery cell 10 may be derived by measuring a difference between a reference thickness of the upper battery cell 10 and an actual height from a second reference surface in contact with the upper surface of the upper battery cell 10 to the lower surface 12 of the upper battery cell 10.

In some embodiments, in a state that the upper surface 12 of the upper battery cell 10 is in contact with the second reference surface, the difference between the reference thickness of the battery cell and the actual height of each point may be continuously measured by irradiating a laser in the stacking direction (e.g., the vertical direction) on the lower surface 12 of the upper battery cell 10 to derive the profile of the lower surface 12 of the upper battery cell 10.

The “reference thickness” may be an average of thickness values of the thickest point and the thinnest point among points where the thicknesses of the lower battery cell 20 and the upper battery cell 10 are different.

The above-described measurement may be performed along the length or width direction of the battery cell. In some embodiments, the measurement may be performed in the length and width directions of the battery cell. Accordingly, a 3D profile of the bonding space may be derived by continuously measuring the distance in the stacking direction along both the length and width directions together.

For example, a laser may be irradiated vertically on the upper surface 21 of the lower battery cell 20 and the lower surface 12 of the upper battery cell 10, and the difference between the reference thickness and the actual height of each point may be measured through a reflected laser light reflected at each point on the surface of the battery cell.

When the profile of the upper surface 21 of the lower battery cell 20 or the profile of the lower surface 12 of the upper battery cell 10 is derived by irradiating the laser, a laser light source may be moved for each surface, and the difference between the reference height and the actual height at each point may be continuously measured.

In the profile of the upper surface 21 of the lower battery cell 20 and the profile of the lower surface 12 of the upper battery cell 10, the difference between the reference thickness and the actual height each point may be in a range of ±0.01 μm to ±1000 μm.

In example embodiments, the profile of the lower surface 12 of the upper battery cell 10 and the profile of the upper surface 21 of the lower battery cell 20 may be continuously derived along the length direction or the width direction of the battery cell.

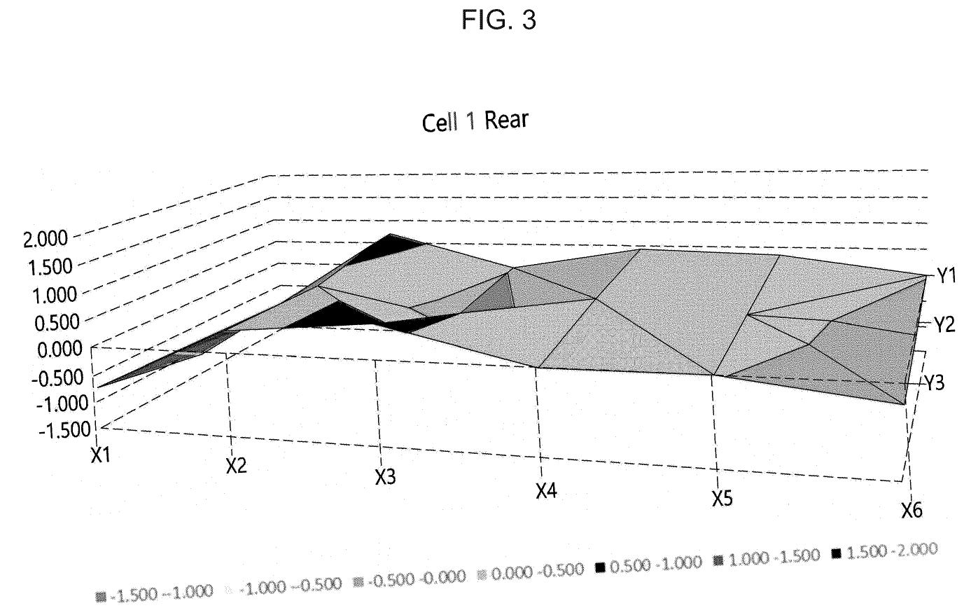

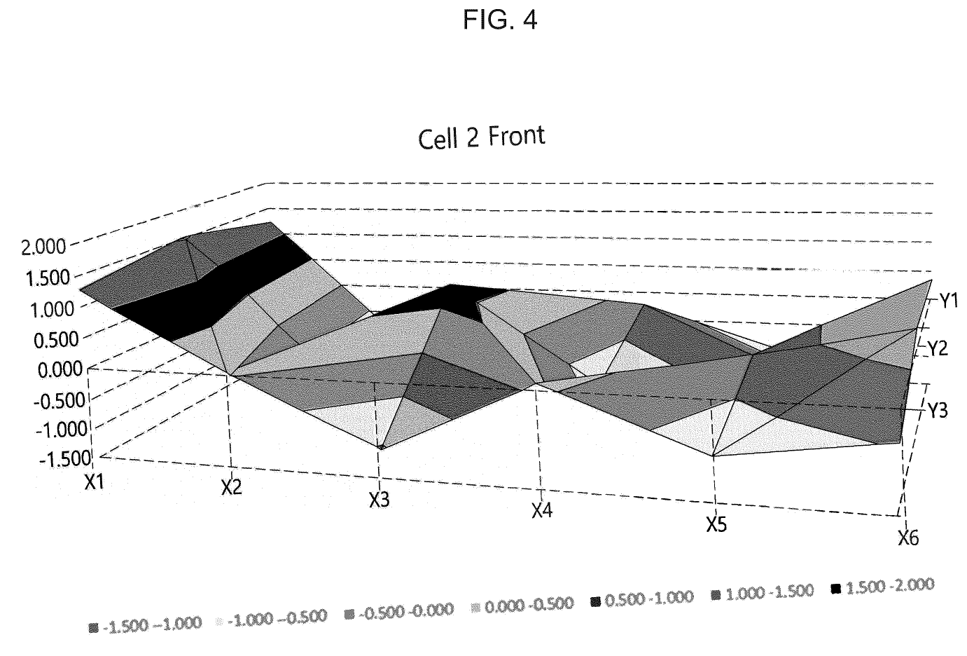

FIG. 3 is a three-dimensional graph showing a lower surface profile of an upper battery cell in accordance with an example embodiment. FIG. 4 is a three-dimensional graph showing an upper profile of a lower battery cell in accordance with an example embodiment.

In FIGS. 3 and 4, a Z-axis represents the stacking direction, an X-axis represents the length direction of the battery cell, and the Y-axis represents the width direction of the battery cell. A brightness of a contour region is shown differently in units of 0.5 μm.

Referring to FIG. 3, the profile of the lower surface 12 of the upper battery cell 10 may be derived by measuring ae height of each point of the battery cell with respect to a reference thickness represented by 0.000 of the Z-axis that is the stacking direction.

Referring to FIG. 4, the profile of the upper surface 21 of the lower battery cell 20 may be derived by measuring a height of each point of the battery cell with respect to a reference thickness represented by 0.000 of the Z-axis that is the stacking direction.

The space profile may be derived by continuously measuring a distance between the derived profile of the lower surface 12 of the upper battery cell 10 and the profile of the upper surface 21 of the lower battery cell 20.

For example, the profile of the lower surface 12 of the upper battery cell 10 and the profile of the upper surface 21 of the lower battery cell 20 may be virtually arranged so that each point may correspond, and the distance between the corresponding points the profile of the lower surface 12 of the upper battery cell 10 and the profile of the upper surface 21 of the lower battery cell 20 may be continuously measured to derive the space profile.

The profile of the lower surface 12 of the upper battery cell 10 and the profile of the upper surface 21 of the lower battery cell 20 may be virtually arranged so as not to overlap each other. For example, a profile surface of the lower surface 12 of the upper battery cell 10 and a profile surface of the upper surface 21 of the lower battery cell 20 may be virtually arranged so as not to cross each other and to be spaced apart from each other. In this case, the space profile may be defined as a space between the profile surface of the lower surface 12 of the upper battery cell 10 and the profile surface of the upper surface 21 of the lower battery cell 20.

For example, referring again to FIGS. 3 and 4, the profiles of FIGS. 3 and 4 may be virtually arranged in the Z-axis direction so that each point defined on the X-axis and Y-axis surfaces corresponds to each other.

The smallest distance among distances between a thickness of the thinnest portion (e.g., H2 in FIG. 2), i.e., the lower surface of the upper battery cell and points corresponding to the upper surface of the lower battery cell may be in a range from 0.01 μm to 10 μm.

The largest distance among distances between a thickness of the thickest portion (e.g., H3 in FIG. 2), i.e., the lower surface of the upper battery cell and points corresponding to the upper surface of the lower battery cell may be in a range from 0.1 μm to 15 μm.

In some embodiments, the space profile may be derived for a partial area or an entire area on the upper surface 21 of the lower battery cell 20 and the lower surface 12 of the upper battery cell 10.

For example, the space profile may include a first region and a second region separated from each other and spaced apart from each other in the length direction.

In example embodiments, the adhesive resin composition may be continuously sprayed onto the upper surface of the lower battery cell in the length direction or the width direction of the battery cell while changing a moving rate of a nozzle based on the thickness of the space profile (e.g., an operation of S30).

When the moving rate of the nozzle decreases, a residence time at one point may become increased. Accordingly, an amount of the adhesive resin composition discharged from the nozzle and deposited at the point may be increased.

When the movement speed of the nozzle increases, the residence time at one point may become short. Accordingly, the amount of the adhesive resin composition discharged from the nozzle and deposited at the point may be reduced.

In an embodiment, when the thickness of the space profile increases, the moving rate of the nozzle may be reduced. When the thickness of the space profile decreases, the moving rate of the nozzle may be increased.

In an embodiment, when the thickness of the space profile increases, the moving rate of the nozzle may be increased. When the thickness of the space profile decreases, the moving rate speed of the nozzle may be reduced. In this case, a larger amount of the adhesive resin composition may be applied to a portion having a narrow gap between cells due to a small thickness of the space profile to improve an adhesion force of a specific region when attaching the cell.

In example embodiments, the moving rate of the nozzle may be reduced when the thickness of the space profile is greater than a reference value from a reference rate when the thickness of the space profile is the reference value. The moving rate of the nozzle may be increased when the thickness of the space profile is less than the reference value.

For example, the moving rate of the nozzle may have a relation with the thickness of the space profile as represented by Equation 1 below.

$$V = {{v}_{0} ( 1 + αΔ P )}^{n} \qquad [ Equating 1 ]$$

In Equation 1, V is a moving rate at one point of the nozzle, ν₀ is the reference rate when passing a point corresponding to the reference thickness of the space profile, ΔP is a difference between the reference thickness of the space profile and a thickness of the space profile at the one point, a is a non-zero, non-dimensional constant as a correction value, and n may be 0 or a positive value.

α of Equation 1 may vary according to a viscosity and a temperature of the adhesive resin composition, a ambient temperature, a discharge pressure of the adhesive resin composition discharged from the nozzle, etc.

ΔP is the difference between the reference thickness of the space profile and a thickness of the space profile at the one point, and may be a negative or a positive value. When the thickness of the space profile of the one point is the same as the reference thickness, ΔP may be 0.

In some embodiments, the adhesive resin composition may be applied to a partial area of the battery cell. For example, the partial area may be an area in which a distance between the upper surface 21 of the lower battery cell 20 and the lower surface 12 of the upper battery cell 10 is 60% or less, 50% or less, or 40% or less of a maximum distance.

For example, if the maximum distance (a maximum thickness of the space profile) between the upper surface 21 of the lower battery cell 20 and the lower surface 12 of the upper battery cell 10 identified from the space profile is 15 μm, the adhesive resin composition may be applied to a region that may be a collection of points where the distance between the upper surface of the lower battery cell and the lower surface of the upper battery cell is 9 μm or less, 7.5 μm or less, or 6 μm or less.

In some embodiments, when the space profile includes a first region and a second region separated from each other in the length direction, the adhesive resin composition may be continuously sprayed within the first region and the second region, respectively.

For example, the two spaced regions spaced apart from each other where a distance between the upper surface of the lower battery cell and the lower surface of the upper battery cell is 60% or less, 50% or less, or 40% or less of a maximum distance may correspond to the first region and the second region, respectively. Accordingly, an amount of the adhesive resin composition used in the battery cell stack may be reduced.

When the adhesive resin composition is continuously sprayed within the first region and the second region, the nozzle may continuously move within the first region to spray the adhesive resin composition, and then the injection may be stopped. Thereafter, the nozzle may move to the second region and the nozzle may move continuously within the second region again, and the adhesive resin composition may be sprayed. In this case, the space profile may include an injection pause period in which the injection is stopped in a space between the first region and the second region.

In example embodiments, the adhesive resin composition may be continuously sprayed along the length direction and the width direction based on the three-dimensional profile.

In example embodiments, the adhesive resin composition may be sprayed at a temperature in a range from 140° C. to 200° C. When the adhesive resin composition is sprayed within the temperature range, the adhesive resin composition may be applied to maintain a shape corresponding to a contour of the lower surface of the upper battery cell while filling the irregularities on the upper surface of the lower battery cell.

In example embodiments, the adhesive resin composition may include a non-solvent-type (solvent-free) adhesive. For example, the non-solvent-type adhesive may be a pressure-sensitive adhesive (PSA). In an embodiment, the adhesive resin composition may include the pressure-sensitive adhesive capable of a non-solvent or hot melt coating.

In example embodiments, the non-solvent-type adhesive may include at least one selected from the group consisting of an ethylene vinyl acetate resin, a polyamide resin, a fatty acid polyamide resin, a polyester resin, a polyurethane resin, a polyolefin resin, a styrene-based resin, a rubber-based resin, etc.

In example embodiments, the adhesive resin composition may include a flame retardant. The flame retardant may include at least one of a phosphorus-based flame retardant and a nitrogen-based flame retardant to provide effective flame retardancy of the adhesive resin composition.

The phosphorus-based flame retardants may include a phosphate compound, a phosphonate compound, a phosphine oxide compound, a phosphazene compound, a metal salt thereof, etc. These may be used alone or in a combination of two or more therefrom.

For example, non-limiting examples of the phosphorus-based flame retardant may include diphenyl phosphate, diaryl phosphate, triphenyl phosphate, tricresyl phosphate, trixyrenyl phosphate, tri(2,6-dimethylphenyl)phosphate, tri(2,4,6-trimethylphenyl)phosphate, tri(2,4-ditertiary butylphenyl)phosphate, tri(2,6-dimethylphenyl)phosphate, bisphenol-A bis(diphenyl phosphate), resorcinol bis(diphenyl phosphate), resorcinol bis[bis(2,6)-dimethylphenyl)phosphate], resorcinol bis[bis(2,4-ditertiarybutylphenyl)phosphate], hydroquinone bis[bis(2,6-dimethylphenyl)phosphate], hydroquinone bis[bis(2,4-ditertiary butylphenyl)phosphate], an oligomeric phosphoric acid ester-based compound, etc. These may be used alone or in a combination of two or more therefrom.

The nitrogen-based flame retardant may include melamine and a melamine derivative. These may be used alone or in a combination of two or more therefrom.

For example, non-limiting examples of the nitrogen-based flame retardant may include melamine, melamine phosphate, melamine cyanurate, etc. These may be used alone or in a combination of two or more therefrom.

In example embodiments, the flame retardant may be included in an amount of 10 parts by weight to 50 parts by weight based on 100 parts by weight of the adhesive resin composition. The phosphorus-based flame retardant and the nitrogen-based flame retardant may be used alone or may be used together within the above-mentioned content range.

After the spraying of the adhesive resin composition is completed, a shape of the coated adhesive resin composition may correspond to the shape of the space profile.

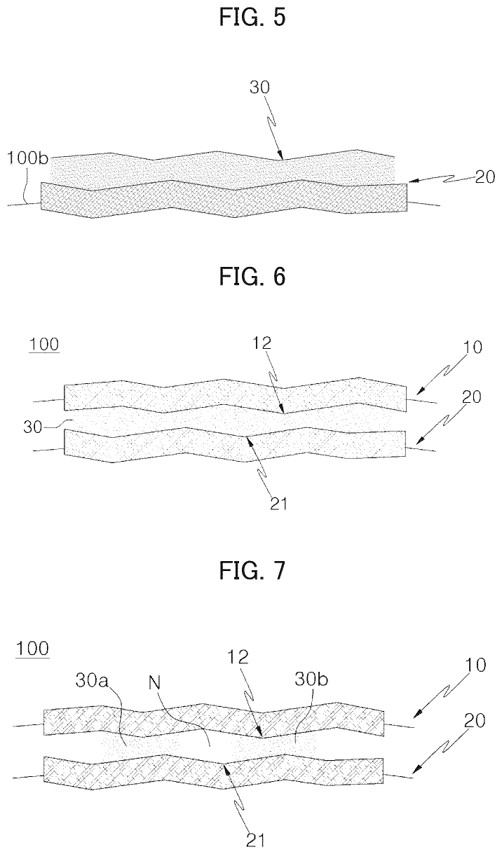

FIG. 5 is a schematic cross-sectional view illustrating an adhesive resin composition applied on a lower battery cell in accordance with an example embodiment.

Referring to FIG. 5, the shape of the adhesive resin composition 30 applied on the upper surface of the lower battery cell 20 may correspond to the shape of the space profile. For example, the adhesive resin composition may have a shape corresponding to a space between the upper surface of the lower battery cell and the lower surface of the upper battery cell.

In example embodiments, the lower surface of the upper battery cell may be stacked to be in contact with the sprayed adhesive resin composition (e.g., an operation of S40).

FIG. 6 is a schematic cross-sectional view of a battery cell stack in accordance with an example embodiment.

Referring to FIG. 6, the lower surface 12 of the upper battery cell 10 may be stacked to be in contact with the adhesive resin composition 30 applied on the upper surface 21 of the lower battery cell 20.

As illustrated in FIG. 6, the adhesive resin composition may be compatible with the contours of the upper surface 21 of the lower battery cell 20 and the lower surface 12 of the upper battery cell 10. Accordingly, when forming the battery cell stack, the cells may be firmly adhered without slipping.

FIG. 7 is a schematic cross-sectional view of a battery cell stack in accordance with an example embodiment.

Referring to FIG. 7, the lower surface 12 of the upper battery cell 10 may be stacked to be in contact with adhesive resin composition 30a and 30b applied on the upper surface 21 of the lower battery cell 20.

As described above, the adhesive resin compositions 30a and 30b may be applied to first and second regions 30a and 30b separated from each other, and a battery cell stack may be manufactured by stacking the upper battery cells 10 to match each region. An injection pause section N is a space in which the adhesive resin composition is not sprayed, and may be a spaced region between the first and second regions 30a and 30b.

According to the method of manufacturing a battery cell stack according to example embodiments, the battery cell stack including two or more battery cells may be manufactured. A plurality of the battery cells may be stacked by repeatedly performing the above-described battery cell stacking method. For example, the battery cell stack may include 2 to 100 battery cells. The battery cell stack may include a structure in which 2 to 100 battery cells are stacked in the same direction.

What is claimed is:

1. A method of manufacturing a battery cell stack, comprising:
aligning a lower battery cell and an upper battery cell with a bonding space interposed therebetween in a stacking direction of battery cells;
continuously measuring a distance in the stacking direction between an upper surface of the lower battery cell and a lower surface of the upper battery cell along a length direction or a width direction of the battery cells to derive a bonding space profile;
spraying an adhesive resin composition on the upper surface of the lower battery cell along the length direction or the width direction while changing a moving rate of a nozzle based on a thickness of the profile; and
attaching the lower surface of the upper battery cell onto the sprayed adhesive resin composition.

2. The method of claim 1, wherein spraying the adhesive resin composition comprises reducing the moving rate of the nozzle when the thickness of the bonding space profile increases, and increasing the moving rate of the nozzle when the thickness of the bonding space profile decreases.

3. The method of claim 1, wherein deriving the bonding space profile comprises:
measuring a difference between a reference thickness of the lower battery cell and an actual height from a first reference surface in contact with a lower surface of the lower battery cell to the upper surface of the lower battery cell to derive an upper surface profile of the lower battery cell;
measuring a difference between a reference thickness of the upper battery cell and an actual height from a second reference surface in contact with a upper surface of the upper battery cell to the lower surface of the upper battery cell to derive a lower surface profile of the upper battery cell; and
continuously measuring a distance between the lower surface profile of the upper battery cell and the upper surface profile of the lower battery cell.

4. The method of claim 3, wherein deriving the upper surface profile of the lower battery cell and deriving the lower surface profile of the upper battery cell are performed by irradiating a laser on each of the upper surface of the lower battery cell and the lower surface of the upper battery cell in the stacking direction.

5. The method of claim 1, wherein the bonding space profile includes a first region and a second region spaced apart from each other in the length direction or the width direction, and
spraying the adhesive resin composition comprises continuously spraying the adhesive resin composition in each of the first region and the second region.

6. The method of claim 5, wherein the bonding space profile includes a spray pause section in a space between the first region and the second region.

7. The method of claim 1, wherein spraying the adhesive resin composition while changing the moving rate of the nozzle comprises:
setting a reference rate when a thickness of the bonding space profile is a reference value; and
reducing the moving rate of the nozzle when the thickness of the bonding space profile is greater than the reference value, and increasing the moving rate of the nozzle when the thickness of the bonding space profile is smaller than the reference value.

8. The method of claim 1, wherein deriving the bonding space profile comprises continuously measuring a distance in the stacking direction along both the length direction and the width direction to generate a three-dimensional profile of the bonding space.

9. The method of claim 8, wherein spraying the adhesive resin composition includes continuously spraying the adhesive resin composition along the length direction and the width direction based on the three-dimensional profile.

10. The method of claim 1, wherein each of the lower battery cell and the upper battery cell comprises:
an electrode assembly comprising a plurality of anodes and cathodes;
an electrolyte solution impregnating the electrode assembly; and
a case accommodating the electrode assembly and the electrolyte solution.

11. The method of claim 1, wherein the lower battery cell and the upper battery cell each includes a pouch-type battery cell.

12. The method of claim 1, wherein the adhesive resin composition includes a solvent-free adhesive.

13. The method of claim 12, wherein the solvent-free adhesive may include at least one selected from the group consisting of an ethylene vinyl acetate resin, a polyamide resin, a fatty acid polyamide resin, a polyester resin, a polyurethane resin, a polyolefin resin, a styrene-based resin and a rubber-based resin.

14. The method of claim 1, wherein the adhesive resin composition is sprayed at a temperature in a range from 140° C. to 200° C.
